(19) United States
(12) Patent Application Publication
(10) Pub. No.: US 2017/0065982 A1
(43) Pub. Date: Mar. 9, 2017

(54) Comminution Machine Having Stationary Anvil And Rotating Hammer Strike Iron

(71) Applicant: AKAI GMBH & CO. KG, Kolbermoor (DE)

(72) Inventor: Alexander Koslow, Landshut (DE)

(21) Appl. No.: 15/308,040

(22) PCT Filed: Apr. 23, 2015
(86) PCT No.: PCT/DE2015/000198

§ 371 Date: Oct. 31, 2016

(30) Foreign Application Priority Data
Apr. 30, 2014 (DE) 10 2014 006 354.2
Oct. 28, 2014 (DE) 10 2014 016 322.9

(51) Int. Cl. B02C 13/28

(52) U.S. Cl. CPC B02C 13/28; B02C 2013/2808

(57) ABSTRACT

A comminution machine having a stationary anvil and rotating hammer strike iron. In such machines, when hammer heads are worn out, the entire hammer strike iron must always be replaced, insofar as a uniform quality is to be achieved in the comminuted material. This is very cost-intensive. The invention thus proposes a novel hammer strike iron having an insert piece which has a cylindrical, eccentric bore or an eccentric oblong hole for receiving a swivel pin of the comminution machine. The insert piece has cheeks of differing thickness on both ends, such that, by rotating the insert piece in the hammer strike iron by 180°, the distance between the hammer head and the anvil can be varied. If a hammer head has been inadmissibly worn, the insert piece can be removed, turned 180°, and reinstalled. The gap between the anvil and the hammer head can thus be uniformly regulated.

### FIELD OF THE INVENTION

The invention relates to a hammer iron for a crushing machine having a stationary anvil, crushing machines having such hammer irons, and a method for operating such crushing machines.

### BACKGROUND OF THE INVENTION

For crushing scrap metal or other mixed materials, today's industries have at their disposal crushing machines, such as hammer mills and shredders, for example. These machines are configured such that hammer irons (hereinafter also referred to as hammers) are pivotably mounted on a rotor by means of a swivel pin, and as the rotor rotates, the centrifugal forces produced by the rotation force the hammers radially outward toward a stationary anvil, which is fixedly connected to a machine frame. The fineness of the crushed material is determined by the gap that is formed between the anvil and the hammer strip. In this process, care must be taken to ensure that when the rotor is rotating at its maximum speed, the distance between anvil and hammer head (i.e., the part of the hammer that protrudes the farthest) does not drop below a predetermined minimum or exceed a predetermined maximum. Any contact between hammer head and anvil must be avoided, as it would result in the destruction of the machine. Likewise, exceeding the maximum permissible gap or distance between hammer head and anvil would significantly impair the functionality of the machine. In such cases, the size of the crushed material would no longer satisfy requirements for the desired particle size.

For such a crushing machine to function properly, the size of the gap between hammer head and anvil head is therefore of crucial importance. To keep the size of the gap between hammer head and anvil within predefined tolerances even as the hammer head becomes worn, it has heretofore been necessary to replace worn hammers with new hammers. This is very time-consuming, as until now this has required a new hammer to be procured. Furthermore, a new hammer is very expensive. It is therefore in the interest of industry to extend the useful life (service life) of a hammer.

### SUMMARY OF THE INVENTION

It is the object of the invention to provide improved hammer irons for a crushing machine of the aforementioned type, which have an extended service life for the purpose of reducing operating costs, without negatively impacting the quality of the crushed product.

This object is achieved by the invention, which is specified in the independent claims; embodiments of the invention are specified in the dependent claims.

To achieve the stated object, the invention discloses hammer irons for a crushing machine having a stationary anvil, wherein the hammer iron is pivotably mounted on a rotor of the crushing machine by means of a swivel pin. Provided in the hammer iron is an insert piece which has an opening for receiving the swivel pin, and which may be installed in a first orientation or in a second orientation. The receiving opening defines a first bearing surface for the swivel pin in the first orientation of the insert piece and a second bearing surface for the swivel pin in the second orientation of the insert piece. The first bearing surface in the first orientation of the insert piece has a different distance from the hammer head (and thus from the anvil) from the second bearing surface in the second orientation of the insert piece.

In one embodiment, the hammer has an insert piece that receives the swivel pin, by means of which the hammer is pivotably mounted on the rotor, in a simple cylindrical bore, which is introduced eccentrically along the longitudinal axis of the insert piece and defines mutually opposing bearing surfaces.

In another embodiment, the pivot pin is guided through an elongated slot, which is arranged eccentrically along the longitudinal axis of the insert piece and defines mutually opposing bearing surfaces.

In both embodiments, the elongated or oval insert piece is replaceably installed in the longitudinal extension of the hammer. The position of the bore introduced eccentrically along the longitudinal axis of the insert piece for receiving the swivel pin, or the position of the elongated hole introduced eccentrically along the longitudinal axis determines the various thicknesses of the two cheeks at the ends of the insert piece; the inner surface of the bore or of the elongated hole that points toward the hammer head forms a bearing surface against which the swivel pin rests when the hammer is in its swiveled out operating state. The two cheeks are located, one at each of the two ends of an insert piece in the longitudinal direction.

The eccentric bore is configured such that the distance between the bore inner wall and the adjacent end of the insert piece is different in size as viewed longitudinally along the insert piece and in the centrifugal force that is produced during rotation. The same is true of the elongated hole. What is crucial here is that by rotating the insert piece 180° in the hammer, the distance between hammer head and bearing surface is varied, and thus when the hammer is installed, the distance between hammer head and anvil is also varied.

This requirement is met in both the cylindrical bore and the elongated slot. For this purpose, the insert piece has cheeks of different thicknesses at its opposing ends. When the hammer is thrown outward by centrifugal force, the bearing surface of one cheek of the insert piece bears against the swivel pin and determines the distance between the hammer head and the anvil. The bearing of the one cheek of the insert piece against the swivel pin limits the movement of the hammer in the direction of the anvil. The thicknesses of the two opposing cheeks of the insert piece are different in both a cylindrical eccentric bore and an eccentric elongated slot. They thus define different distances between the hammer head and the anvil, depending on which cheek of the insert piece the swivel pin comes to rest against.

Because the two cheeks delimit either a cylindrical eccentric bore or an eccentric elongated slot in an insert piece, rotating the insert piece 180° in the hammer is sufficient to vary the distance between hammer head and anvil. Thus if a greater thickness of one cheek of the insert piece corresponds to the desired gap between anvil and hammer head when the hammer is new, then when the insert piece is rotated 180°, the bearing of the swivel pin against the other, thinner cheek will again correspond to the desired nominal distance between anvil and hammer head even when the hammer head has become worn.

The insert piece is provided replaceably in the hammer, either in a tight fit or attached by conventional fastening means. To adapt the assignment of swivel pin and cheek, or bearing surface, to the different needs arising between the new hammer and its worn state, it is necessary according to the invention only to remove the insert piece and reinstall it rotated 180° into the hammer. A thinner cheek then allows the hammer to be thrown by centrifugal forces close enough to the anvil to form a gap between anvil and hammer head which corresponds to the nominal gap that would be formed by a new hammer. A corresponding number of insert pieces having different cheek thicknesses thus allows an adequate response to hammer wear. Expediently, insert pieces having cheeks with different wall thicknesses may be kept on hand to enable the area of application of a single hammer and its service life to be optimally exploited.

Furthermore, the invention not only extends the service life of a hammer, but also significantly impacts the safety of the machine when insert pieces that have an elongated hole are used. In that case, when oversized or hard components are fed to the machine for crushing, the hammer, which is guided in the elongated hole, is able to move away from the anvil, counter to the centrifugal forces, increasing the gap between anvil and hammer head. This is the additional advantage provided when the swivel pin, about which the hammer rotates, is arranged in an elongated slot of an insert piece in the hammer.

With a cylindrical, eccentric bore in the insert piece, destruction of the machine can be avoided only if all components are designed as extremely sturdy to enable the hammer to be thrown back against the centrifugal forces. In this case it is also critical to ensure that when loading the machine, parts that are difficult to crush are not fed into the machine.

### BRIEF DESCRIPTION OF THE DRAWINGS

In the following, embodiment examples of the invention will be described in greater detail with reference to the attached figures. Shown are:

FIG. 1 is a plan view of the schematic design of a crushing machine, in which hammer irons according to the invention may be used.

FIG. 2 is a plan view of a hammer according to a first embodiment example of the invention for a crushing machine according to FIG. 1.

FIG. 3 is a cross-section of a hammer according to FIG. 2.

FIG. 4 is a cross-section of a hammer according to a second embodiment example of the invention for a crushing machine according to FIG. 1.

FIG. 5 is a plan view of the hammer according to FIG. 4.

### DETAILED DESCRIPTION OF THE INVENTION

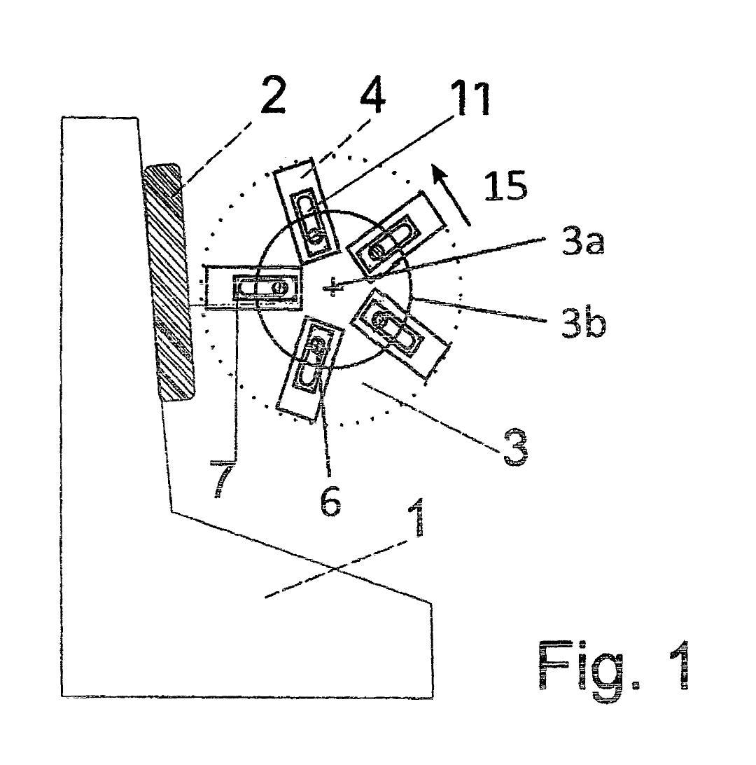

FIGS. 1 to 3 show a first embodiment example of a hammer for a crushing machine.

FIG. 1 shows a plan view of a vertical crushing machine, in which the drive shaft 3a of the rotor 3 extends perpendicular to the plane of the drawing. On the drive shaft of the rotor, disks 3b are arranged one above the other, each of which has an opening for mounting the swivel pin 6. One or more hammers 4 are each suspended on a swivel pin between two disks, optionally with the use of spacer rings. Corresponding arrangements may also be used in crushing machines in which the drive shaft of the rotor is arranged horizontally.

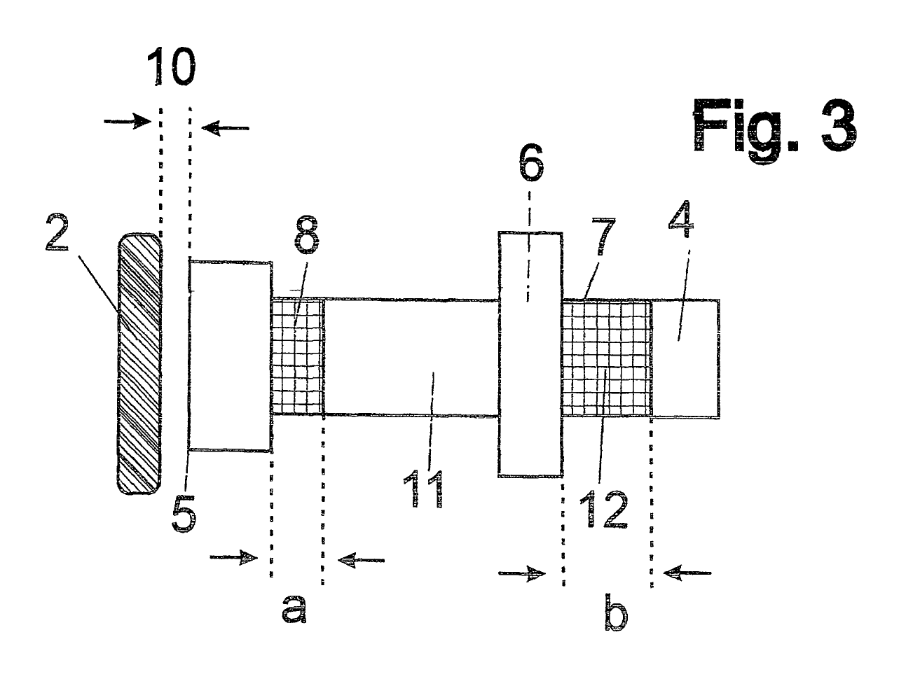

The anvil 2, which is fixedly mounted on a machine frame 1, cooperates during operation with the hammer head 5 of a hammer 4. A gap 10 is formed between anvil 2 and hammer head 5, as shown in FIG. 3. This gap 10 increases as the hammer head 5 becomes worn. This gap 10 is relevant to the fineness of the crushed material. When the hammer is new, the insert piece is mounted such that during operation, the swivel pin 6 bears against the inner side of the thicker cheek 12 of the insert piece 7. In this case, nothing bears against the thinner cheek 8, which is opposite this cheek 12 in the insert piece 7.

The thickness (b) of the cheek 12, as measured up to the adjacent end of the insert piece 7, is greater than the thickness (a) of the opposite cheek 8, likewise measured up to end of the insert piece 7 adjacent to that cheek 8. The difference in the thickness of the two opposing cheeks 8; 12 corresponds to the degree of wear on the hammer head 5 that would have necessitated replacing the hammer 4 with a new hammer.

Insert piece 7 is replaceably connected to hammer 4 via fastening means 9 or via a tight fit. Insert piece 7 has along its center line an elongated hole 11, which is delimited at the ends of the insert piece by the cheeks 8; 12 and which receives swivel pin 6. Swivel pin 6 is in turn fixedly attached to two adjacent disks 3b of the rotor 3. When the hammer is new, swivel pin 6 bears against the thicker cheek 12 having the thickness (b) of the insert piece 7, and a gap 10 having a nominal width is formed between hammer head 5 and anvil 2. If the gap 10 increases as a result of wear on the hammer head 5, the gap can be returned to its nominal width by removing the insert piece 7 and reinstalling it rotated 180°, so that during operation, swivel pin 6 bears against the inner side of the thinner cheek 8 having the thickness (a); if, for example, the wear is 0.3 mm, an insert piece in which the thicknesses of the two cheeks differ accordingly, i.e. b−a=0.3 mm, will be selected.

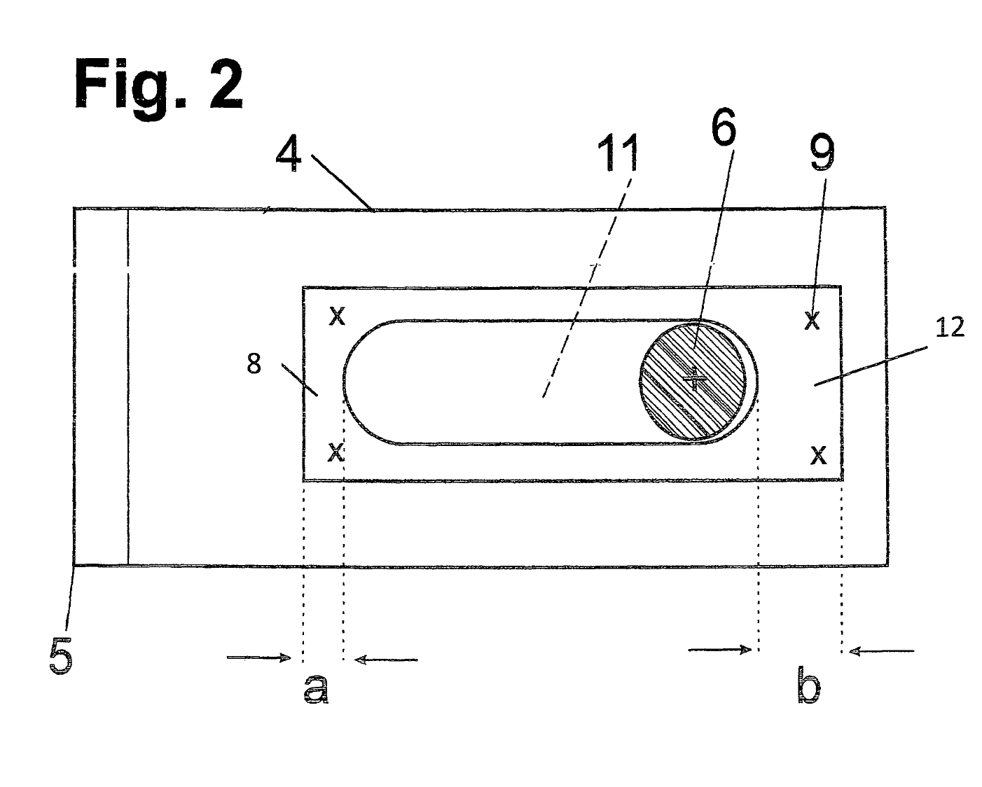

FIGS. 2 and 3 show the insert piece 7 in an orientation corresponding to a new hammer, so that during operation, the swivel pin bears against the thicker cheek 12.

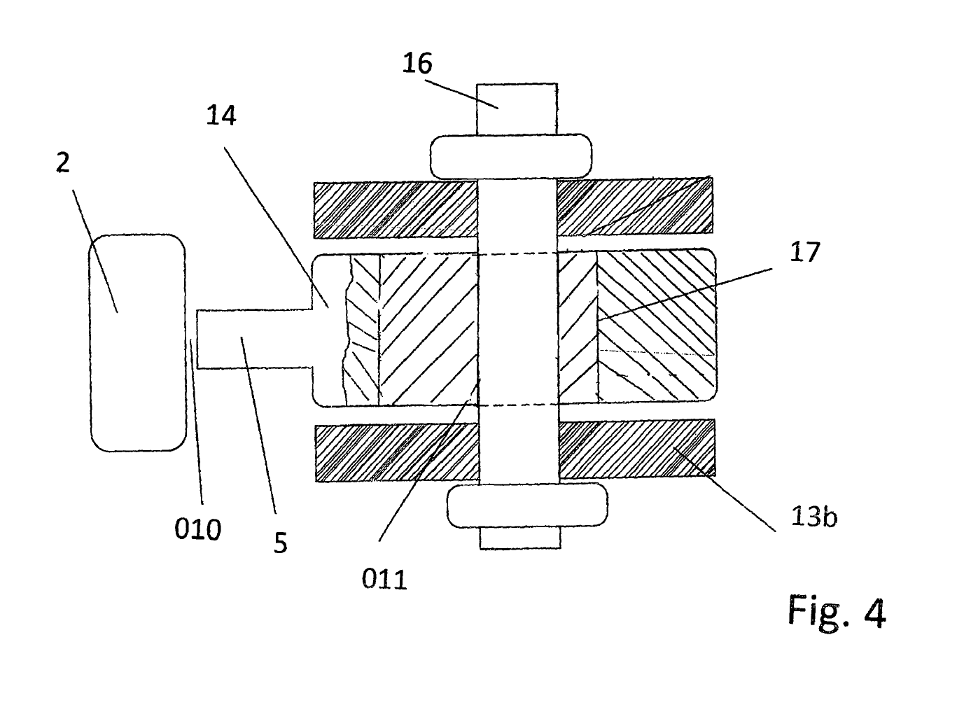

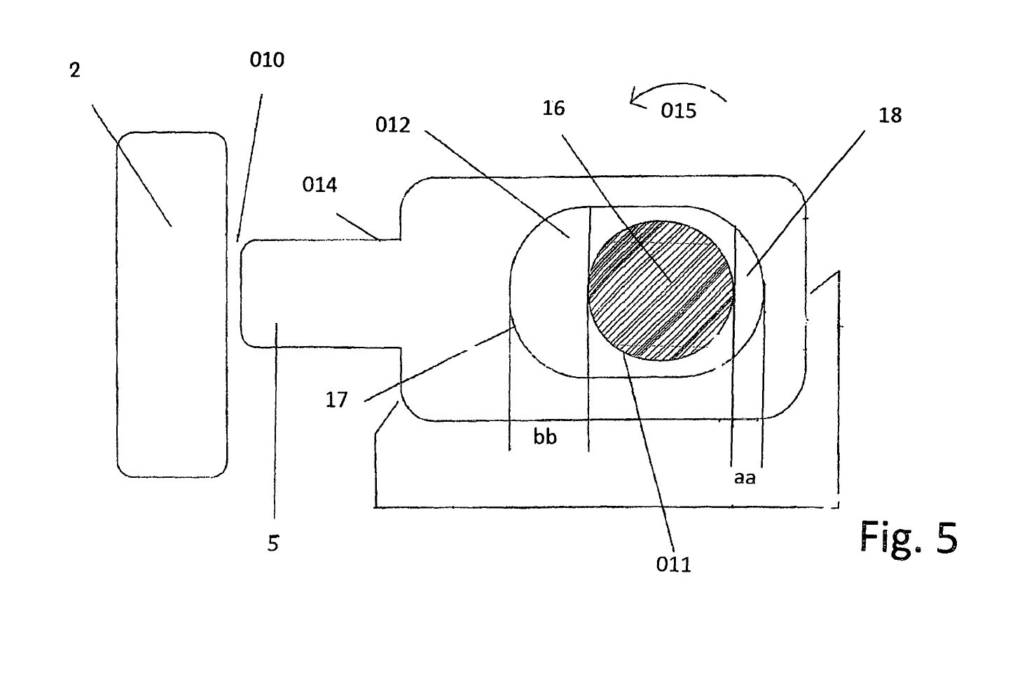

FIGS. 4 and 5 show a second embodiment example of a hammer according to the invention for a crushing machine of the type mentioned in the introductory part. An anvil 12 is fixedly mounted on a machine frame and cooperates during use with the hammer head 5 of a hammer 14. Between anvil 12 and hammer head 5, a gap 010 is formed. This gap 010 increases as the hammer head 5 becomes worn. This gap 010 is relevant to the fineness of the crushed material.

When the hammer is new, during operation the swivel pin 16 bears against the thicker cheek 012 of the insert piece 17. In this case, nothing bears against cheek 18, which is opposite this cheek 012 in the insert piece 17. The thickness (bb) of cheek 012, measured up to the adjacent end of the insert piece 17, is greater than the thickness (aa) of the opposite cheek 18, likewise measured up to the adjacent end of the insert piece 17. The difference in the thickness of the two cheeks 18; 012 corresponds to the degree of wear on hammer head 5 that would have necessitated replacing the hammer 14 with a new hammer 14.

Insert piece 17 is affixed replaceably and in a precise fit in the hammer 14, for example with fastening means. Insert piece 17 has a cylindrical bore 011, which is arranged eccentrically along the longitudinal axis of the insert piece 17, so that the distance between hammer head 5 and anvil 12 can be varied by the respective cheek 18; 012 of different thickness when the replaceable elongated insert piece 17 is rotated 180°. The swivel pin 16 is guided through the cylindrical bore 011 and is attached to the rotor disks 13b of the rotor. When the hammer being used is new, swivel pin 16 bears against the inner side of cheek 012 of the insert piece 17 and creates a gap 010 between hammer head 5 and anvil 12 which has a nominal width corresponding to a cheek thickness (bb) in the insert piece 17. If the gap 010 increases as a result of wear on the hammer head 5, the gap 010 can be returned to its desired nominal width by removing the insert piece 17 and reinstalling it rotated 180°, so that during operation, swivel pin 16 bears against the cheek 18 that has the smaller thickness (aa); wear on the hammer head of 0.3 mm, for example, can be compensated for by reinstalling an insert piece having cheek thicknesses (aa), (bb), with bb−aa=0.3 mm, in reverse orientation.

FIGS. 4 and 5 show insert piece 17 in an orientation corresponding to a worn hammer, so that during operation, the swivel pin bears against the thinner cheek 18.

The insert piece (7; 17) is preferably made of high-strength steel. The bearing surfaces of the swivel pin (6; 16) may also be tempered.

In the bearing surfaces, lubricating holes are preferably provided, which can be connected to a central lubricating device.

In other embodiments of the invention, insert pieces may be used which define different bearing surfaces for the swivel pin even when they are rotated less than 180° in the hammer, for example rotationally symmetrical insert pieces that have an eccentric bore for the swivel pin.

In an expedient embodiment of the crushing machine, a plurality of hammer irons 4; 14 are mounted close enough to a swivel pin that an adjacent hammer iron 4; 14 prevents the insert piece 7; 17 from falling out.

In both embodiments, by keeping multiple insert pieces 7; 17 that have cheeks 8; 18 and 12; 012 of different thicknesses on hand, and by simply changing out the insert pieces, the hammers 4; 14 may be optimally utilized until they are ultimately worn out, thereby substantially reducing the costs of operating the crushing machine. The size of the gap between anvil and hammer head can be adjusted within a wide range and with a precision in the submillimeter range. The hammer irons according to the invention can be produced with little added expense.

### LIST OF REFERENCE SIGNS

1 machine frame

2 anvil

3 rotor

3a drive shaft of the rotor

3b; 13b rotor disk for mounting the swivel pin

4; 14 hammer, hammer iron

5 hammer head

6; 16 swivel pin

7; 17 insert piece

8 cheek at one end of the elongated hole in the insert piece

9 fastening means for the insert piece in the hammer

10; 010 gap between anvil and hammer head

11 elongated hole in the insert piece of one embodiment

011 cylindrical bore in the insert piece of a second embodiment

12 cheek opposite the cheek 8 of the elongated hole in the insert piece

012 cheek at one end of the eccentric cylindrical bore in the insert piece

15; 015 direction of rotation of the rotor

18 cheek opposite cheek 012 of the eccentric cylindrical bore in the insert piece

1. A hammer iron for a crushing machine having a stationary anvil (2), wherein the hammer iron (4; 14) is mounted pivotably on a rotor (3) of the crushing machine by means of a swivel pin (6; 16), characterized in that in the hammer iron, an insert piece (7; 17) is provided, which contains a receiving opening (11; 011) having a first bearing surface (8; 18) and a second bearing surface (12; 012) for the swivel pin, and which can be installed in the hammer iron in a first orientation or in a second orientation, wherein the first bearing surface in the first orientation and the second bearing surface in the second orientation are at different distances from the hammer head (5; 15).

2. The hammer iron according to claim 1, wherein the first and second bearing surfaces are opposite one another, and the first orientation is rotated 180° relative to the second orientation.

3. The hammer iron according to claim 2, wherein the receiving opening is a cylindrical bore (011), formed eccentrically in the insert piece (17), so that cheeks (18; 012) of the insert piece (17) which are opposite one another along the longitudinal axis of the hammer head (5) and which serve as bearing surfaces have different wall thicknesses.

4. The hammer iron according to claim 2, wherein the receiving opening is an elongated hole (11), formed eccentrically in the insert piece, so that cheeks of the insert piece which are opposite one another along the longitudinal axis of the hammer head (5) and which serve as bearing surfaces have different wall thicknesses.

5. The hammer iron according to any of claims 1 to 4, characterized in that the insert piece (7; 17) is made of high-strength steel.

6. The hammer iron according to any of claims 1 to 4, characterized in that the bearing surfaces have lubricating holes which can be connected to a central lubricating device.

7. The hammer iron according to any of claims 1 to 6, characterized in that the insert piece (7; 17) is guided in a recess in the hammer iron, forming a tight fit.

8. A crushing machine with hammer irons (4; 14) according to any of claims 1 to 7, the bearing surfaces of which have defined distances from a stationary anvil (2).

9. The crushing machine according to claim 8, characterized in that a plurality of hammer irons (4; 14) are mounted on the swivel pin close enough to one another that adjacent hammer irons (4; 14) prevent the insert piece (7; 17) from falling out.

10. A method for operating a crushing machine according to claim 8 or 9, characterized in that a plurality of insert pieces (7; 17), each having different bearing surfaces, are kept on hand so that the width of the gap (10; 010) between anvil (2) and hammer head (5) can be adjusted.
